(19) United States
(12) Patent Application Publication
(10) Pub. No.: US 2006/0206388 A1
(43) Pub. Date: Sep. 14, 2006

(54) Method of quickly identifying availability of rental properties being advertised on the internet

(76) Inventor: David Ray Burritt, Broomfield, CO (US)

Correspondence Address: David Ray Burritt, 1350 Bellaire, Broomfield, CO, 80020, US

(21) Appl. No.: 11/078,137

(22) Filed: Mar. 11, 2005

(51) Int. Cl. G06Q 30/00; G06F 17/30; G06F 17/00

(52) U.S. Cl. 705/26; 707/3; 707/104.1

(57) ABSTRACT

This invention describes a method where people using the Internet to find properties to rent from owners can easily sort out what properties are available for the time period that they are interested in. This patent application is mainly targeted for rental properties being managed by individual owners but it could also apply to any piece of property(s) being rented over the Internet.

### TECHNICAL FIELD

This invention relates to how people select what propertyJ they may want to rent over the Internet when they are presented with multiple options

### CROSS REFERENCE TO RELATED APPLICATIONS

None

### BACKGROUND OF THE INVENTION

Within this document, the followxing term s shall be used:

Browser: A program. which runs on a user's computer and connects to a Web Server (via the Internet). The purpose of a browser is to allow a user to easily get information from the Internet. Microsoft's “Internet Explorer” computer program is an example of a Browser.

Web Server: A computer designed for returning web pages to a users browser.

Site: Same as Web Server

Calendar: In this document, the term calendar shall be used as a mechanism for showing what dates a piece of rental property is available for rent. For example, a month may be shown in a typical 4 week by 7 day table with each cell of the table representing a day in the month. The cells which represent days that are not available might be shown in the color red and the cells which represent days that are available may be shown in white. However, the calendar may be displayed in any manner, which the user could easily identifying as being something which represents days ot the month in which the calendar represents. The calendar may display availability information about 1 or more days. In most cases the calendar would be organized on a monthly basis, but that is not required for this document.

Within the prior art, it is well known how to list a set of properties (typically condominiums) which are available for rent on the Internet. Typically, these properties are listed by the owners themselves. There are many web sites which facilitate this (e.g., www.vrbo.com, www.alvacations.com, www.rentalo.com, etc.). These sites typically present a list of properties that are available for a short term rental (typically for a vacation). These sites usually display limited information about the property and also provide a link that the user can follow on his/her browser (e.g., Microsoft's Internet Explorer) which will take the user's browser to a more detailed page. Once the user is viewing this page he/she may have the ability to follow another link to display a calendar which shows the availability of the property.

If the user is interested in multiple properties then this can become very tedious, as it requires the user to keep moving between multiple web pages. In order to keep track of the information the user has to do one of the following:
1. Keep multiple instances of the web browser up with each instance showing the particular property.
2. The user has to take manual notes (either on paper or on his or her computer) about the availability of each property
3. The user has to have a very good memory and remember the availability calendar for each property.

All of the above options are very tedious for the user.

### SUMMARY OF THE INVENTION

The aforementioned problems are solved and a technical advance is achieved in the art by a method that uses a computer program which goes out to a common database (or set of databases) to get availability information (calendar) and then display the calendars along with some property information on a single web page. This will allow the user to easily identify what properties are available during the time period that they are interested. In addition, another benefit is that the user can see how much the rental property is booked into the future (or even in the past if the calendar shows past bookings). This booking information can tell the user how popular a particular rental property is.

### BRIEF DESCRIPTION OF THE DRAWING

FIG. 1 illustrates, in block diagram form, an embodiment of the invention.

FIG. 2 illustrates, in block diagram form, another embodiment of the invention.

FIG. 3 illustrates, in block diagram form, another embodiment of the invention.

FIG. 4 illustrates, in block diagram form, another embodiment of the invention.

FIG. 5 illustrates, in block diagram form, another embodiment of the invention.

FIG. 6 illustrates a sample flow of information

### DETAILED DESCRIPTION

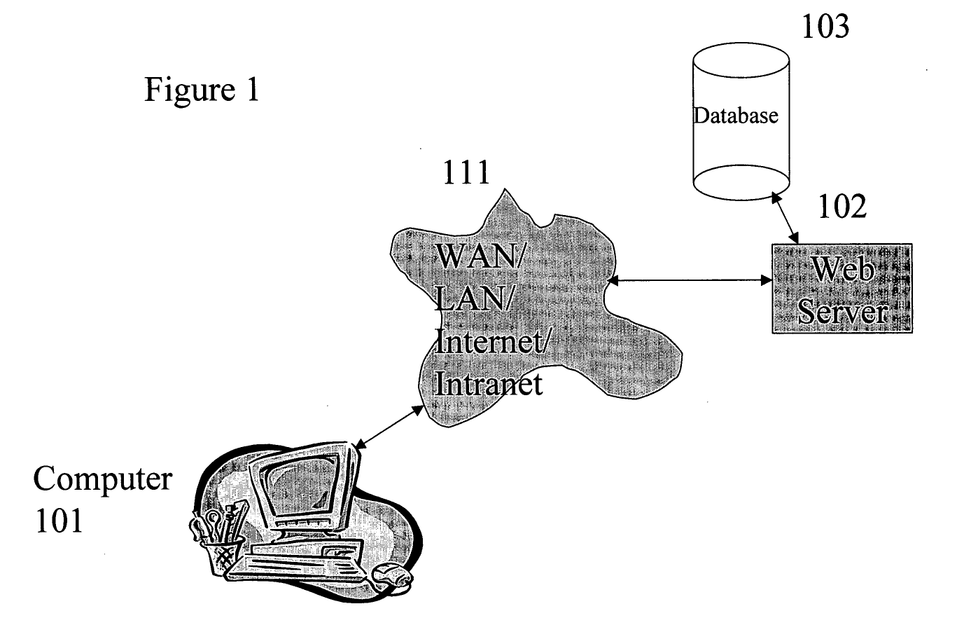

FIG. 1 illustrates an embodiment for implementing the invention. Computer 101 has connectivity to the Internet via any available means (e.g., Dial up, DSL, cable modem, T1, 802.11, GSM, GPRS, CDPD, etc). The computer connects to server 102 (e.g., web server) in order to get a list of properties that are available which matches the user's request (e.g., 1 bedroom in Keystone Colo.). In the process of getting the list, the web server communicates to a database 103 which has the availability information regarding each property. The web server returns the list of properties along with the availability information to the user's browser. The user can now easily view information about each property including the availability information (probably, but not required, to be presented as a calendar).

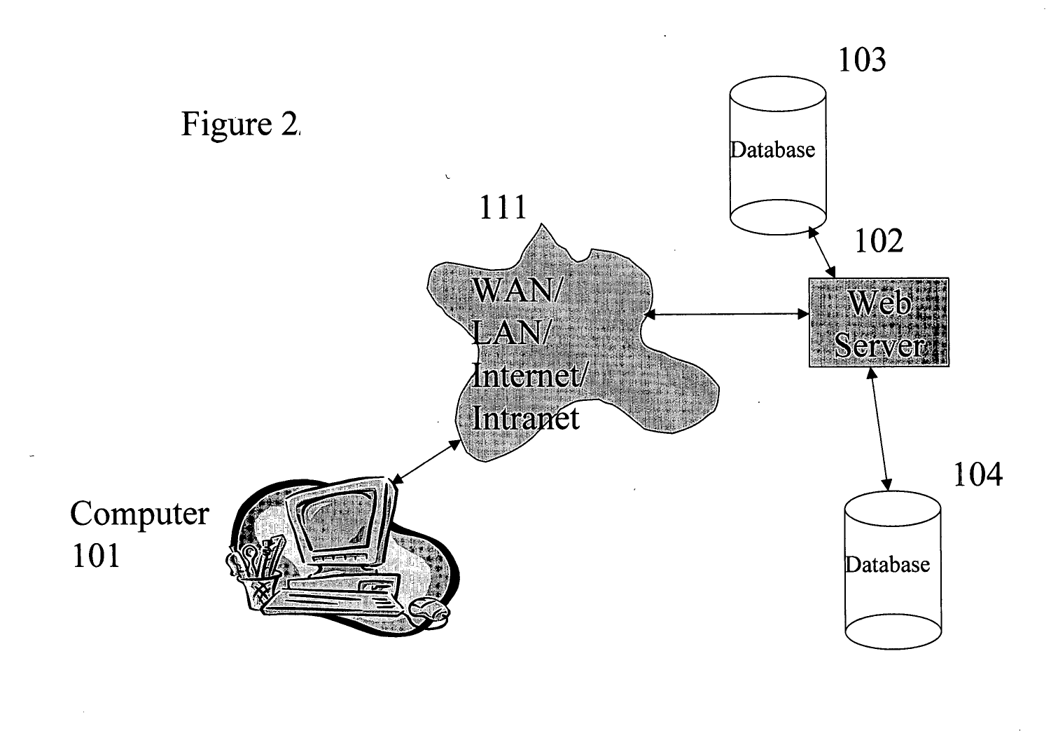

FIG. 2 illustrates an embodiment for implementing the invention. Computer 101 has connectivity to the Internet via any available means (e.g., Dial up, DSL, cable modem, T1, 802.11, GSM, GPRS, CDPD, etc). The computer connects to server 102 (e.g., web server) in order to get a list of properties that are available which matches the user's request (e.g., 1 bedroom in Keystone Colo.). In the process of getting the list, the web server communicates to a databases 103 and 104 which has the availability information regarding the properties. The web server returns the list of properties along with the availability information to the user's browser. The user can now easily view information about each property including the availability information (probably, but not required, to be presented as a calendar). The main difference between this and FIG. 1 is that the availability information does not have to be stored in a single database. The information may be contained in 2 or more databases.

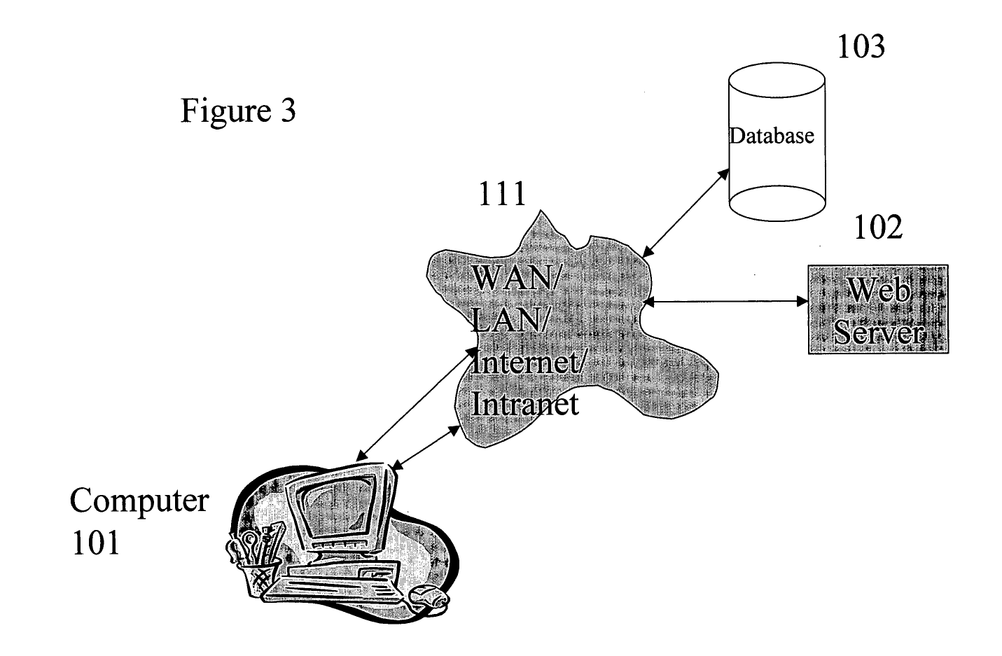

FIG. 3 illustrates an embodiment for implementing the invention. Computer 101 has connectivity to the Internet via any available means (e.g., Dial up, DSL, cable modem, T1, 802.11, GSM, GPRS, CDPD, etc). The computer connects to server 102 (e.g., web server) in order to get a list of properties that are available which matches the user's request (e.g., 1 bedroom in Keystone Colo.). The web server returns the list of properties to the user's browser. Once the list is returned, the computer (instead of the web server) accesses the database 103 and gets the data. The main difference between this and FIG. 1 is that the web browser is communicating to the database instead of the web server. This will decrease the load on the web server.

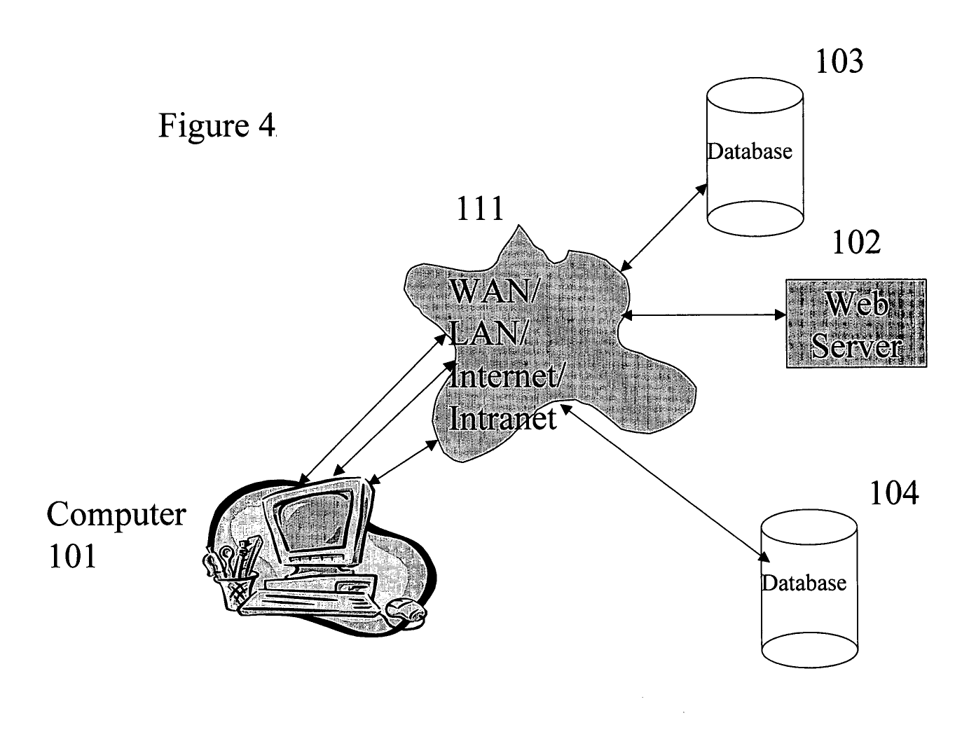

FIG. 4 illustrates an embodiment for implementing the invention. Computer 101 has connectivity to the Internet via any available means (e.g., Dial up, DSL, cable modem, T1, 802.11, GSM, GPRS, CDPD, etc). The computer connects to server 102 (e.g., web server) in order to get a list of properties that are available which matches the user's request (e.g., 1 bedroom in Keystone Colo.). The web server returns the list of properties to the user's browser. Once the list is returned, the computer (instead of the web server) accesses multiple databases (103 and 104) and gets the availability data (calendar). The main difference between this and FIG. 3 is that the web browser is communicating multiple databases instead of a single database which returned the initial list of properties. This will decrease the load on the web server.

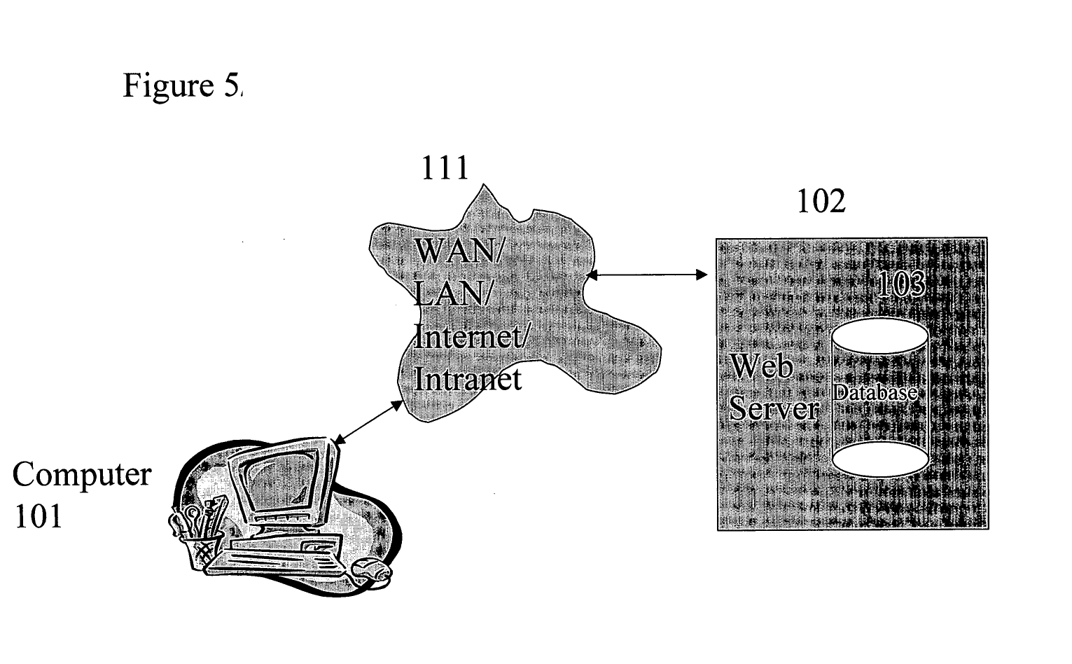

FIG. 5 illustrates an embodiment for implementing the invention. Computer 101 has connectivity to the Internet via any available means (e.g., Dial up, DSL, cable modem, T1, 802.11, GSM, GPRS, CDPD, etc). The computer connects to server 102 (e.g., web server) in order to get a list of properties that are available which matches the user's request (e.g., 1 bedroom in Keystone Colo.). In the process of getting the list, the web server communicates to an internal database 103 (i.e., one that resides on the the same computer as the web server computer) which has the availability information regarding each property. The web server returns the list of properties along with the availability information to the user's browser. The user can now easily view information about each property including the availability information (probably, but not required, to be presented as a calendar).

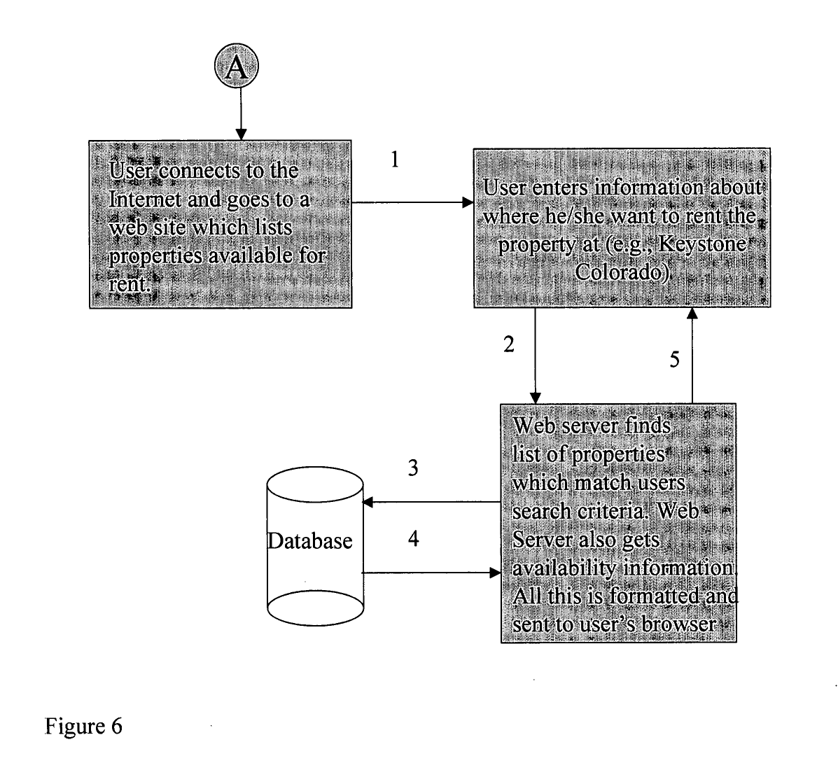

FIG. 6 illustrates the movement of data in a sample scenario.

Execution starts at A.

User connects to the Internet

User starts Web Browser and goes to a web site whose goal is to find rental properties based on some criteria the user provides (e.g., 1 bedroom units in Keystone Colo.)

Web Browser connects to the site (via the Internet).

The site (Web Server) finds the matching set of properties which match the user's search criteria.

The site (Web Server) also accesses a database which provides availability information (e.g. calendar) for 1 or more of the properties.

The site (Web Server) then formats the data in a manner that the user's browser can understand and returns the data to the user's browser.

The browser displays the results on the user's monitor.

While the invention has been described by means of specific embodiments, numerous modifications and variations could be made thereto by those skilled in the art without departing from the scope and spirit of the invention set forth in the claims.

What is claimed is:

1. A method to show information on a single web page which conveys the availability for more than one piece of property that is being advertised for rental via the Internet.

2. While this invention mainly pertains to the rental of vacation property it could also apply to the rental of anything over the Internet. Therefore, this invention applies to multiple things being advertised for rent via the Internet where such information is showing up on a single page.
